(19) United States
(12) Patent Application Publication
(10) Pub. No.: US 2017/0136403 A1
(43) Pub. Date: May 18, 2017

(54) FILTER ELEMENT AND MANUFACTURING METHOD THEREOF

(71) Applicant: SUPER LEGEND LIMITED, Hong Kong (HK)

(72) Inventor: Kok Chiang CHUNG, Singapore (SG)

(21) Appl. No.: 15/347,475

(22) Filed: Nov. 9, 2016

(30) Foreign Application Priority Data
Nov. 13, 2015 (CN) 201510778503.6

(51) Int. Cl. B01D 53/04; B01D 15/08; B01D 29/11; B01D 39/20

(52) U.S. Cl. CPC B01D 53/0431; B01D 39/2062; B01D 15/08; B01D 29/114; B01D 2239/086; B01D 2253/102; B01D 2101/005; B01D 2253/304

(57) ABSTRACT

The present invention relates to a filter element for filtering particulate materials in a fluid, comprising a first filtration zone comprising first-size particles and a second filtration zone comprising second-size particles, as well as a transition zone comprising a mixture of first-size particles and second-size particles and interconnecting the first filtration zone and the second filtration zone. Preferably, the filter element is a carbon block formed by sintering two types of activated carbon particles having different sizes and ultra-high-molecular-weight polyethylene around them. The filter element of the present invention has both higher filtration capacity and higher absorption capacity. In addition, the present invention further relates to a method for manufacturing the filter element of the present invention.

### TECHNICAL FIELD OF THE INVENTION

This invention relates to a filter element for filtering particulate materials in a fluid, in particular to a carbon block filter element comprising a plurality of filtration zones configured to filter particulate materials of various sizes, and a manufacturing method thereof.

### BACKGROUND OF THE INVENTION

A carbon block for filtration is made from activated carbon particles and an appropriate binder. Methods of manufacturing carbon blocks in the prior art comprise pressureless sintering and pressure sintering of the carbon blocks. No matter which method is used, the structure of the carbon block obtained is homogeneous, i.e. pores formed between activated carbon particles are substantially of equal size, filtering all particulate materials smaller than a pore size of the pores.

Small size of activated carbon particles may be selected for manufacturing carbon blocks having high chlorine absorption capacity. However, when activated carbon particles are of small size, a pressure drop across both sides of the carbon block increases and the inter-particle pores in the carbon block are easily clogged by particulate materials in a fluid. This type of filtration in which small size of surface inter-particle pores causes tiny particulate materials to clog the pores so that flowing of a fluid is blocked is called surface filtration. In this type of filtration, although inside the carbon block there are still many activated carbon particles not fully utilized to absorb chlorine, the fluid to be treated cannot contact these activated carbon particles.

In another aspect, in order to prevent the surface inter-particle pores from being clogged, certain carbon blocks are made from larger size of activated carbon particles. However, the larger size of activated carbon particles causes a pressure across both sides of the carbon block to drop significantly, making the flow rate of a fluid flowing through the carbon block increase significantly, i.e. making the retention time of the fluid in the carbon block decrease significantly, thus the absorbing capacity of the activated carbon particles in the carbon block for particulate materials in a fluid is severely affected. In addition, as the size of the activated carbon particles increases, the size of the inter-particle pores in the carbon block will also increase, allowing passage of the particulate materials of smaller size (such as size less than 1 μm) therethrough. Certain carbon blocks can even only filter particulate materials of a size greater than 5 μm.

Therefore, currently there is a need for a filter element that has both higher filtration capacity (which is able to filter particulate materials of smaller size) and higher absorption capacity (which make full use of the activated carbon particles inside the carbon block to absorb the particulate materials).

### SUMMARY OF THE INVENTION

To solve the above technical problems, an object of the present invention is providing a filter element, such as a carbon block, formed by sintering granular materials, wherein a first filtration zone consists of filter materials of larger particle size (such as activated carbon) and is located upstream of the flowing direction of a fluid, the first filtration zone being used for filtering particulate materials of larger size; a second filtration zone consists of filter materials of smaller particle size and is located downstream of the flowing direction of the fluid, the second filtration zone being used for filtering the particulate materials of smaller size and being also able to absorb the particulate materials; and between the first filtration zone and the second filtration zone exists a transition zone which consists of a mixture of filter materials of larger size and filter materials of smaller size. Such filter element can both filter particulate materials of smaller size and fully utilize filter materials deep inside the filter element to absorb the particulate materials, i.e. having both higher filtration capacity and higher absorption capacity. Moreover, such filter element is less prone to be clogged by the particulate materials and thus has longer service life.

In particular, the present invention provides a filter element for purifying particulate materials in a fluid, comprising a first filtration zone and a second filtration zone, the first filtration zone comprising a collection of first-size particles with first-size inter-particle pores formed therebetween, the second filtration zone comprising a collection of second-size particles with second-size inter-particle pores formed therebetween, an average size of the first-size particles being greater than an average size of the second-size particles so that the first-size inter-particle pore have a pore size greater than the second-size inter-particle pore; wherein the filter element further comprises a transition zone interconnecting the first filtration zone and the second filtration zone, the transition zone being formed from a mixture of the first-size particles and the second-size particles in such a way that the transition zone has inter-particle pores whose pore size gradually decreases from the pore size of the first-size inter-particle pores to the pore size of the second-size inter-particle pores viewed in a direction from the first filtration zone to the second filtration zone.

In an embodiment of the filter element of the present invention, the transition zone has a gradually decreasing content of the first-size particles and a gradually increasing content of the second-size particles viewed in the direction from the first filtration zone to the second filtration zone.

In an embodiment of the filter element of the present invention, the first filtration zone is positioned upstream of the second filtration zone in the flowing direction of the fluid.

In an embodiment of the filter element of the present invention, both the first-size particles and the second-size particles are selected from activated carbon particles.

In an embodiment of the filter element of the present invention, the activated carbon particles comprise polyethylene particles as a binder surrounding the activated carbon particles. Preferably, the polyethylene is ultra-high-molecular-weight polyethylene (UHMWPE). More preferably, the ultra-high-molecular-weight polyethylene has a viscosity in a range of 1200 ml/g to 4300 ml/g.

In an embodiment of the filter element of the present invention, the first-size particles have a particle size of greater than 250 μm, and the second-size particles have a particle size of between 60 μm and 200 μm. Preferably, the first filtration zone is configured to filter particulate materials having a particle size of greater than 200 μm, and allow particulate materials having a particle size of less than 200 μm to penetrate into and/or pass through the first filtration zone, the transition zone is configured to filter particulate materials having a particle size of between 1 μm and 200 μm, and the second filtration zone is configured to filter particulate materials having a particle size of greater than 1 μm.

In an embodiment of the filter element of the present invention, the first filtration zone, the second filtration zone and/or the transition zone are made from a material capable of absorbing particulate materials, in particular chlorine. Preferably, particulate materials are mainly absorbed in the second filtration zone.

In an embodiment of the filter element of the present invention, the filter element is formed as a sintered cylindrical structure in which the first filtration zone surrounds the transition zone that in turn surrounds the second filtration zone. In other words, the first filtration zone is closer to the outer side of the filter element, the second filtration zone is closer to the inner side of the filter element, and the transition zone is located between the first filtration zone and the second filtration zone.

Another aspect of the present invention provides a method for manufacturing the filter element comprising the steps of: providing a mold having a cavity adapted for housing granular materials, the mold comprising a network for partitioning the cavity into a first cavity and a second cavity; filling the first cavity and the second cavity with the first-size particles and the second-size particles respectively, wherein an average size of the first-size particles is greater than an average size of the second-size particles; removing the network from the mold in such a way that the first-size particles and the second-size particles are caused to move toward each other to form a transition zone interconnecting the first filtration zone and the second filtration zone; sintering the first-size particles and the second-size particles at an appropriate temperature to respectively form a first filtration zone comprising the first-size particles with first-size inter-particle pores formed therebetween and a second filtration zone comprising the second-size particles with second-size inter-particle pores formed therebetween, the first-size inter-particle pores having a pore size greater than a pore size of the second-size inter-particle pores, and the transition zone being formed by sintering a mixture of the first-size particles and the second-size particles in such a way that the transition zone has inter-particle pores whose pore size gradually decreases from the pore size of the first-size inter-particle pores to the pore size of the second-size inter-particle pores, viewed in a direction from the first filtration zone to the second filtration zone. Preferably, the temperature of the sintering is between 170° C. and 220° C.

According to an embodiment of the method of the present invention, the sintering step is carried out in such a way that the transition zone has a gradually decreasing content of the first-size particles and a gradually increasing content of the second-size particles, viewed in the direction from the first filtration zone to the second filtration zone.

According to an embodiment of the method of the present invention, both the first-size particles and the second-size particles are selected from activated carbon particles.

According to an embodiment of the method of the present invention, the activated carbon particles comprise polyethylene particles as a binder surrounding the activated carbon particles. Preferably, the polyethylene is ultra-high-molecular-weight polyethylene. More preferably, the ultra-high-molecular-weight polyethylene has a viscosity in a range of 1200 ml/g to 4300 ml/g.

According to an embodiment of the method of the present invention, the first-size particle has a size of greater than 250 μm, and the second-size particle has a size of between 60 μm and 200 μm. Preferably, the sintering step is carried out in such a way that the first filtration zone is configured to filter particulate materials having a particle size of greater than 200 μm and allow particulate materials having a particle size of less than 200 μm to penetrate into and/or pass through the first filtration zone, the transition zone is configured to filter particulate materials having a particle size of between 1 μm and 200 μm, and the second filtration zone is configured to filter particulate materials having a particle size of greater than 1 μm.

According to an embodiment of the method of the present invention, the mold has a cylindrical inner wall, a cylindrical outer wall and a cylindrical network having a diameter greater than a diameter of the inner wall but smaller than a diameter of the outer wall. Preferably, the network and the outer wall define the first cavity, and the network and the inner wall define the second cavity.

### BRIEF DESCRIPTION OF THE DRAWINGS

FIG. 1 is a schematic view of the structure of a filter element according to an embodiment of the present invention.

FIG. 2 is a sectional view of a filter element according to another embodiment of the present invention.

FIG. 3 is a schematic view of a mold for manufacturing the filter element of the present invention according to an embodiment of the present invention.

### DETAILED DESCRIPTION OF THE INVENTION

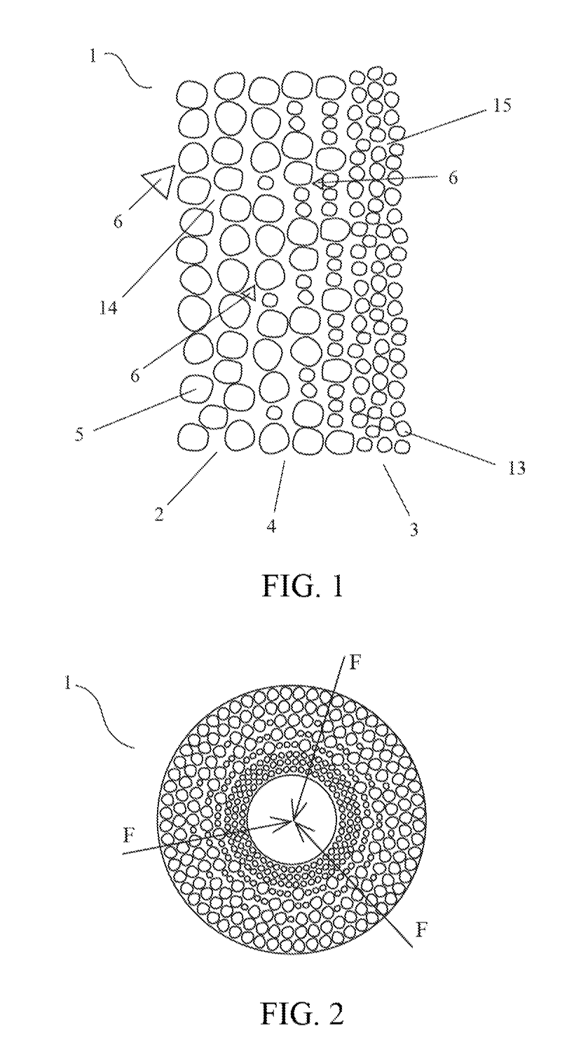

FIG. 1 shows a filter element 1 according to an embodiment of the present invention.

In this embodiment, the filter element 1 is a carbon block, i.e. it is formed from activated carbon particles and an appropriate binder (such as a plastic material). However, it would be within the ability of a person skilled in the art that the filter element of the present invention can be formed form any filter medium, such as ceramic block, sintered PE block, a sintered metal block in any form, etc.

The filter element 1 comprises a first filtration zone 2 located upstream of the fluid flowing direction F, a second filtration zone 3 located downstream of the fluid flowing direction F, and a transition zone 4 interconnecting the first filtration zone 2 and the second filtration zone 3. The first filtration zone 2 comprises a collection of first-size particles. In this embodiment, the first-size particles are large activated carbon particles 5 having a particle size of greater than 250 μm. Polyethylene particles of appropriate size are disposed on at least a part of an outer surface of the large activated carbon particles 5. The function of the polyethylene is to act as a binder between the large activated carbon particles 5 in order to bind the large activated carbon particles 5 together to form the first filtration zone 2. First-size inter-particle pores 14 are formed between the large activated carbon particles 5. The first filtration zone 2 is configured to filter particulate materials 6 having a particle size of greater than 200 μm, i.e. the particulate materials having a particle size of greater than 200 μm will be blocked outside the first filtration zone 2, while allowing the particulate materials having a particle size of 200 μm or less to penetrate into or pass through the first filtration zone 2.

The second filtration zone 3 comprises a collection of second-size particles. In this embodiment, the second-size particles are formed from small activated carbon particles 13 having a particle size of between than 60 μm and 250 μm. The small activated carbon particles 13 also have polyethylene particles of appropriate size acting as a binder surrounding the small activated carbon particles in order to bind the small activated carbon particles 13 together to form the second filtration zone 3. Second-size inter-particle pores 15 are formed between the small activated carbon particles 13. The second filtration zone 3 is configured to filter particulate materials having a particle size of greater than 1 μm. It has been proven experimentally that the large activated carbon particles 5 and the small activated carbon particles 13, on the outer surface of which are disposed ultra-high-molecular-weight polyethylene, in particular ultra-high-molecular-weight polyethylene having a viscosity in a range of between 1200 ml/g and 4300 ml/g, a better filtration effect can be achieved.

As shown in FIG. 1, a transition zone 4 is located between the first filtration zone 2 and the second filtration zone 3, there are both the large activated carbon particles 5 and the small activated carbon particles 13 in the transition zone 4. In addition, the transition zone 4 is configured to have a gradually decreasing content of the large activated carbon particles 5 and a gradually increasing content of the small activated carbon particles 13, viewed in the fluid flowing direction F. Therefore, in the direction from the first filtration zone 2 to the second filtration zone 3, the pore size of an inter-particle pore formed between particles of the transition zone 4 gradually decreases, i.e. gradually decreases starting from the pore size of the first-size inter-particle pore 14 to the pore size of the second-size inter-particle pore 15. The transition zone 4 is configured to filter the particulate materials having a particle size of between 1 μm and 200 μm.

The particulate materials having a particle size of greater than 200 μm and thus being blocked outside the first filtration zone 2 retain on the upstream surface of the first filtration zone 2 and become a part of the filter element 1. Since these particulate materials are of larger size and have larger gaps therebetween, the fluid to be filtered is able to smoothly flow through these gaps between the particulate materials without being blocked. The particulate materials having a particle size of less than 200 μm but greater than 1 μm are able to penetrate into the first filtration zone 2. The particulate materials of this particle size may pass through the first filtration zone 2 and reach the transition zone 4, or may retain inside the first filtration zone 2. Since these particulate materials are still of large size, even though they retain inside the transition zone 4 or inside the first filtration zone 2, the fluid is still able to flow through the gaps formed between the particulate materials. Therefore, these particulate materials having penetrated into or passed through the first filtration zone 2 also become a part of the filter element 1 and functions as a filter medium.

Since the activated carbon particles 13 in the second filtration zone 3 are of smaller size and thus have smaller pore size of inter-particle pores, the second filtration zone 3 is able to block passage of the particulate materials of smaller particle size. In addition, the second filtration 3 also decreases the flow rate of the fluid, thereby extending the retention time of the fluid in the carbon block to allow the contact of the activated carbon particles in the carbon block with the particulate materials in the fluid for a sufficient period of time.

Therefore, the principle of the present invention is based on the depth filtration achieved by a gradient arrangement of particulate materials of different sizes, such that the surface filtration is limited to occur only in the filtration zone located downstream of the fluid flowing direction, thereby making the filter element have both higher filtration capacity and higher absorption capacity. In addition, unlike the prior art filter elements, the filter element of the present invention is not a hierarchical structure, but is configured as a continuous structure having a gradient in terms of particle size and inter-particle pore size. Although the filter element 1 is defined to have the filtration zone 2, the transition zone 4 and the filtration zone 3 herein, a person skilled in the art would appreciate that there is no interface between each two adjacent ones of the three filtration zones. Thus, according to the invention, the filter element 1 can be understood as one filtration zone comprising the large activated carbon particles 5 and the small activated carbon particles 13, in which the content of the large activated carbon particles 5 gradually decreases in the fluid flowing direction, while the content of the small activated carbon particles 13 gradually increases in the fluid flowing direction. Such a gradient structure makes it possible that the filter element 1 of the present invention is able to better filter and/or absorb the particulate materials of various sizes without the proneness of getting clogged.

FIG. 2 shows a filter element 1 according to another embodiment of the present invention. In this embodiment, the first filtration zone 2 and the second filtration zone 3 are both cylindrical, and the first filtration zone 2 surrounds the transition zone 4 that in turn surrounds the second filtration zone 3. In other words, the first filtration zone 2 is closer to the outer side of the filter element 1, the second filtration zone is closer to the inner side of the filter element 1, and the transition zone 4 is located between the first filtration zone 2 and the second filtration zone 3. The fluid flowing direction F is from the outside of the filter element to the inside of the filter element. A person skilled in the art would appreciate that the filter element of the present invention can be formed in any shape and of any size, such as a conical structure, a block structure, etc.

A method of manufacturing a filter element 1 as shown in FIG. 2 according to an embodiment of the present invention is described below. A person skilled in the art would appreciate that the method is not limited to manufacturing the filter element in the form as shown in FIG. 2, and when it is necessary to manufacture a filter element of any other shape, using a mold of a corresponding shape will do.

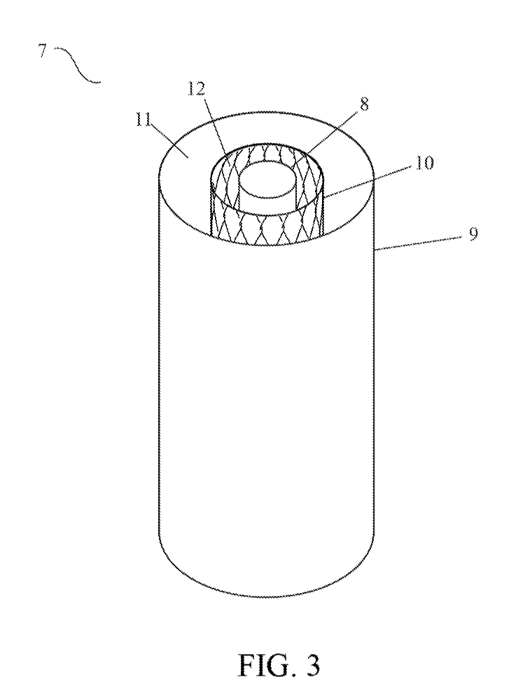

In order to manufacture the filter element 1 as shown in FIG. 2, first of all it is necessary provide a cylindrical mold 7 suitable for housing granular materials, as shown in FIG. 3. The mold 7 can be made from any stable material at a sintering temperature of between 170° C. and 220° C. The mold 7 has a cylindrical inner wall 8 and a cylindrical outer wall 9 that are coaxially arranged. The inner wall 8, the outer wall 9 and both ends of the mold define the space for housing granular materials. A cylindrical network 10 is coaxially arranged with the inner wall 8 and the outer wall 9 in the mold 7. The network 10 has a diameter greater than that of the inner wall 8 but smaller than that of the outer wall 9. In other words, the network 10 is located between the inner wall 8 and the outer wall 9, and partitions the space for housing the granular materials in the mold 7 into a first cavity 11 and a second cavity 12. In particular, the network 10 and the outer wall 9 define the first cavity 11, and the network 10 and the inner wall 8 define the second cavity 12.

In this embodiment, the granular materials for manufacturing the filter element 1 comprise first-size particles, i.e. large activated carbon particles 5 having a particle size of greater than 250 μm, and second-size particles, i.e. small activated carbon particles 13 having a particle size of between than 60 μm and 200 μm. The large activated carbon particles 5 and the small activated carbon particles 13 both have ultra-high-molecular-weight polyethylene particles disposed on the outer surface thereof, said ultra-high-molecular-weight polyethylene particles having a viscosity in a range of between 1200 ml/g and 4300 ml/g. The first cavity 11 between the network 10 and the outer wall 9 is filled with the large activated carbon particles 5, and the second cavity 12 between the network 10 and the inner wall 8 is filled with the small activated carbon particles 13, and then the large activated carbon particles 5 and the small activated carbon particles 13 are appropriately compressed. Afterward, the network 10 is removed out of the mold 7 in a manner that the removal of the network 10 causes the large activated carbon particles 5 and the small activated carbon particles 13 to contact and/or mix at a position where the network 10 has been originally placed. In particular, during the process of removing the network 10, the first-size particles 5 and the second-size particles 13 are caused to move toward each other so that the first-size particles 5 and the second-size particles 13 are re-arranged, with a result that the size of the inter-particle pore formed between the particles in that area gradually decreases inwardly along the radial direction of the mold.

Subsequently, the mold is closed, and the large activated carbon particles 5 and the small activated carbon particles 13 filled in the mold 7 are sintered at a temperature of 170° C.-220° C. At this temperature, the ultra-high-molecular-weight polyethylene disposed on the outer surfaces of the large activated carbon particles 5 and the small activated carbon particles 13 will soften (but will not melt) and bind together so that these activated carbon particles also bind together to form a relatively stable carbon block. The outer portion of this carbon block in which only the large activated carbon particles 5 bind together is the first filtration zone 2. The first-size inter-particle pores 14 are formed between the large activated carbon particles 5 in the first filtration zone 2. The inner portion of the carbon block in which only the small activated carbon particles 13 bind together is the second filtration zone 3. The second-size inter-particle pores 15 are formed between the small activated carbon particles 13 in the second filtration zone 3. At the position where the network 10 is placed before it is removed, the large activated carbon particles 5 and the small activated carbon particles 13 mix and bind together to form a transition zone 4. Since the outer portion of the transition zone 4 is close to the first transition zone 2 consisting of the large activated carbon particles 5 and the inner portion of the transition zone 4 is close to the second transition zone 3 consisting of the second activated carbon particles 13, the thus-formed transition zone 4 has a gradually decreasing content of the large activated carbon particles 5 and a gradually increasing content of the small activated carbon particles 13 in the direction of from the outer portion to the inner portion, the result of which is the pore size of the inter-particle pore formed between the activated carbon particles in the transition zone 4 gradually decreases from the outer portion to the inner portion, starting from the pore size of the first-size inter-particle pore 14 and terminating at the pore size of the second-size inter-particle pore 15.

Although the nature of the present invention has been fully described based on some preferred embodiments, the present invention should not be limited to the structures and functions in said embodiments and figures. It is generally believed that the present invention may be modified in detail as long as the basic principles of the present invention are not changed, altered or modified. Numerous variations and modifications that are easily obtained by combining common knowledge of those skilled in the art without departing from the scope of the present invention should fall within the scope of the present invention.

What is claimed is:

1. A filter element (1) for purifying a fluid, comprising:
a first filtration zone (2), and
a second filtration zone (3),
wherein the first filtration zone (2) comprises a collection of first-size particles (5) with first-size inter-particle pores (14) formed therebetween, the second filtration zone (3) comprises a collection of second-size particles (13) with second-size inter-particle pores (15) formed therebetween, an average size of the first-size particles (5) being greater than an average size of the second-size particles (13) so that the first-size inter-particle pores (14) have a pore size greater than a pore size of the second-size inter-particle pores (15);
characterized in that the first-size particles (5) and the second-size particles are formed from a same filter material, and the filter element (1) further comprises a transition zone (4) interconnecting the first filtration zone (2) and the second filtration zone (3), the transition zone (4) being formed from a mixture of the first-size particles (5) and the second-size particles (13) in such a way that the transition zone (4) has inter-particle pores whose pore size gradually decreases from the pore size of the first-size inter-particle pores (14) to the pore size of the second-size inter-particle pores (15), viewed in a direction from the first filtration zone (2) to the second filtration zone (3).

2. The filter element (1) of claim 1, wherein the transition zone (4) has a gradually decreasing content of the first-size particles (5) and a gradually increasing content of the second-size particles (13), viewed in the direction from the first filtration zone (2) to the second filtration zone (3).

3. The filter element (1) of claim 1, wherein the first filtration zone (2) is positioned upstream of the second filtration zone (3) in a flowing direction (F) of the fluid.

4. The filter element (1) of claim 1, wherein both the first-size particles (5) and the second-size particles (13) are selected from activated carbon particles.

5. The filter element (1) of claim 4, wherein the activated carbon particles comprise polyethylene particles as a binder surrounding the activated carbon particles.

6. The filter element (1) of claim 5, wherein the polyethylene is ultra-high-molecular-weight polyethylene.

7. The filter element (1) of claim 6, wherein the ultra-high-molecular-weight polyethylene has a viscosity in a range of 1200 ml/g to 4300 ml/g.

8. The filter element (1) of claim 1, wherein the first-size particles (5) have a particle size of greater than 250 μm, and the second-size particles (13) have a particle size of between 60 μm and 200 μm.

9. The filter element (1) of claim 8, wherein the first filtration zone (2) is configured to filter particulate materials having a particle size of greater than 200 μm and allow particulate materials having a particle size of less than 200 μm to penetrate into and/or pass through the first filtration zone (2), the transition zone (4) is configured to filter particulate materials having a particle size of between 1 μm and 200 μm, and the second filtration zone (3) is configured to filter particulate materials having a particle size of greater than 1 μm.

10. The filter element (1) of claim 1, wherein the first filtration zone (2), the transition zone (4) and/or the second filtration zone (3) are made from a material which is capable of absorbing particulate materials, in particular chlorine.

11. The filter element (1) of claim 1, wherein the filter element (1) is formed as a sintered cylindrical structure in which the first filtration zone (2) surrounds the transition zone (4) which in turn surrounds the second filtration zone (3).

12. A method for manufacturing the filter element (1) of claim 1, comprising the steps of:
providing a mold (7) having a cavity adapted for housing granular materials, the mold (7) comprising a network (10) for partitioning the cavity into a first cavity (11) and a second cavity (12);
filling the first cavity (11) and the second cavity (12) with the first-size particles (5) and the second-size particles (13) respectively, wherein an average size of the first-size particles (5) is greater than an average size of the second-size particles (13), and the first-size particles (5) and the second-size particles (13) are made from a same filter material;
removing the network (10) from the mold (7) in such a way that the first-size particles (5) and the second-size particles are caused to move toward each other to form a transition zone (4) interconnecting the first filtration zone (2) and the second filtration zone (3);
sintering the first-size particles (5) and the second-size particles (13) at an appropriate temperature to form a first filtration zone (2) comprising the first-size particles (5) with first-size inter-particle pores (14) formed therebetween, and a second filtration zone (3) comprising the second-size particles (13) with second-size inter-particle pores (15) formed therebetween, the first-size inter-particle pores (14) having a pore size greater than a pore size of the second-size inter-particle pores (15), and the transition zone (4) being formed by sintering a mixture of the first-size particles (5) and the second-size particles (13) in such a way that the transition zone (4) has inter-particle pores whose pore size gradually decreases from the pore size of the first-size inter-particle pores (14) to the pore size of the second-size inter-particle pores (15), viewed in a direction from the first filtration zone (2) to the second filtration zone (3).

13. The method of claim 12, wherein the sintering step is carried out in such a way that the transition zone (4) has a gradually decreasing content of the first-size particles (5) and a gradually increasing content of the second-size particles (5), viewed in the direction from the first filtration zone (2) to the second filtration zone (3).

14. The method of claim 12, wherein the temperature is between 170° C. and 220° C.

15. The method of claim 12, wherein both the first-size particles (5) and the second-size particles (13) are selected from activated carbon particles. 16 The method of claim 15, wherein the activated carbon particles comprise polyethylene particles as a binder surrounding the activated carbon particles.

17. The method of claim 16, wherein the polyethylene is ultra-high-molecular-weight polyethylene.

18. The method of claim 17, wherein the ultra-high-molecular-weight polyethylene has a viscosity in a range of 1200 ml/g to 4300 ml/g.

19. The method of claim 12, wherein the first-size particles (5) have a particle size of greater than 250 μm, and the second-size particles (13) have a particle size of between 60 μm and 200 μm.

20. The method of claim 19, wherein the sintering step is carried out in such a way that the first filtration zone (2) is configured to filter particulate materials having a particle size of greater than 200 μm and allow particulate materials having a particle size less than 200 μm to penetrate into and/or pass through the first filtration zone (2), the transition zone (4) is configured to filter particulate materials having a particle size of between 1 μm and 200 μm, and the second filtration zone (3) is configured to filter particulate materials having a particle size of greater than 1 μm.

21. The method of claim 12, wherein the mold has a cylindrical inner wall (8), a cylindrical outer wall (9), and a cylindrical network (10) having a diameter greater than a diameter of the inner wall (8) but smaller than a diameter of the outer wall (9).

22. The method of claim 21, wherein the network (10) and the outer wall (9) together define the first cavity (11), and the network (10) and the inner wall (8) together define the second cavity (12).
